(19) United States
(12) Patent Application Publication
(10) Pub. No.: US 2004/0233403 A1
(43) Pub. Date: Nov. 25, 2004

(54) Device and method for optically scanning a substrate disk

(76) Inventors: Detlef Gerhard, Munchen (DE); Johannes Lechner, Munchen (DE); Detlef Rieger, Baldham (DE)

Correspondence Address: STAAS & HALSEY LLP, SUITE 700, 1201 NEW YORK AVENUE, N.W., WASHINGTON, DC, 20005, US

(21) Appl. No.: 10/490,056

(22) PCT Filed: Sep. 20, 2002
(86) PCT No.: PCT/DE02/03531

(30) Foreign Application Priority Data
Sep. 21, 2001 (DE) 101 46 583.1

(51) Int. Cl. G03B 27/42

(52) U.S. Cl. 355/53

(57) ABSTRACT

An optical scanning system for a substrate disk has an image recording device and an exposure device. The image recording device scans an object line in an area of recording on the substrate disk. The exposure device comprises a light source and an optical system, whereby the optical system is adapted to direct the light emitted by the light source as a linear exposure area onto the position of the object line and evenly distributed across the entire length of the object line to be recorded.

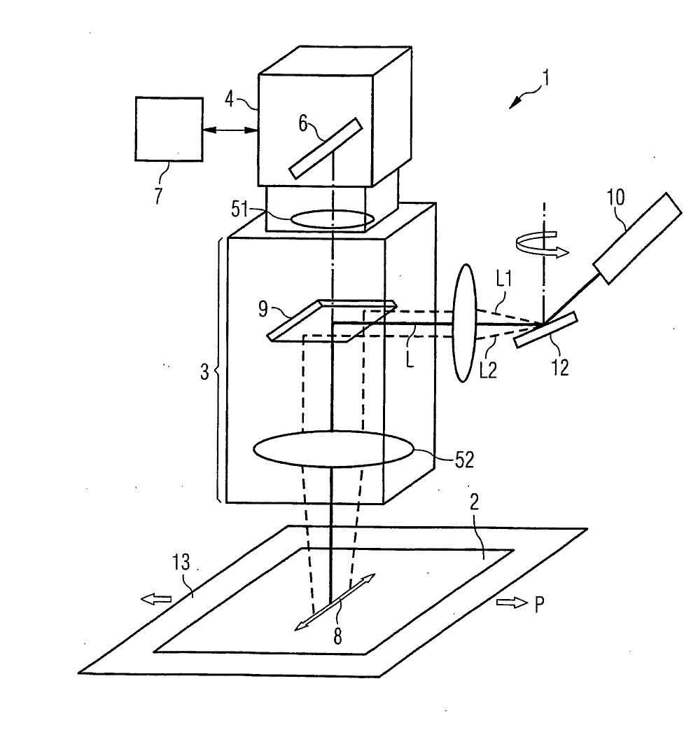

### CROSS REFERENCE TO RELATED APPLICATIONS

This application is based on and hereby claims priority to PCT Application No. PCT/DE02/03531 filed on Sep. 20, 2002 and German Application No.101 46 583.1 filed on Sep. 21, 2001, the contents of which are hereby incorporated by reference.

### BACKGROUND OF THE INVENTION

Integrated circuits are fabricated on substrate disks by technological surface processes such as coating, lithography, structuring, chemical-mechanical polishing, implantation and such like. After the integrated circuits are finished the substrate disks are laminated and the integrated circuits located on the substrate disks are separated individually by a sawing process.

However during the integrated circuit fabrication process there are a plurality of recurring problems, such as those of particles or scratches which destroy or damage structures. E.g. varnishing faults can occur during the lithography process, i.e. in some case there a tears or irregularities in the varnish layer. Such errors can then lead, in the subsequent structuring process, to incorrect structuring, yield losses or to the total destruction of the substrate disk. A further source of errors lies in the positioning accuracy of an exposure mask, where interoperating structures working are set against each other in a disadvantageous way.

For this reason the substrate disk is checked several times during the fabrication process for errors. This involves scanning an image of the surface of the substrate disk and investigating it for particles, scratches, varnishing faults, structures produced etc. The checking of the substrate disk can reveal errors and subsequently decisions can be taken as to how to proceed, such as reworking, discarding individual wafers or release.

The substrate disk is checked using what are referred to as inspection systems.

After a surface treatment process such as coating, varnishing, polishing or such like the substrate disk is checked by adding an unstructured substrate disk to the batch of structured substrate disks before the relevant process is started. After the relevant process step the test substrate disk is investigated for particles, layer thicknesses or similar. Such an investigation typically involves a known halogen lamp as microscope illumination and recording the full extent of the area to be inspected. Irregularities or errors can be found by detecting and evaluating differences in brightness.

In a further procedure the substrate is scanned with a laser and the intensity of the reflected beam is measured using a photomultiplier with a light-sensitive element. The quality of the substrate disk surface can be ascertained by synchronizing scanning angle and timing sequence of the light intensity.

If an error occurs, i.e. too great a particle density or an undesired layer thickness is measured, the batch is removed from the fabrication process and the type of error is evaluated to allow a decision to be made as to how to proceed, such as reworking, discarding individual wafers or release. This process allows the quality of the test substrate disk to be used to decided on the quality of the rest of the batch. Particular disadvantages of this process are the consumption of test substrate disks and the fact that they are very restricted in their use for assessing sawing processes.

If a structured substrate disk is to be investigated, the structures located on it are learned beforehand in a computer system. The structures on the substrate disk to be tested are recorded and the actual recording is compared with the learned required image. This involves using 2D cameras which are moved over the substrate disk and record and analyze the image in this way. Alternatively the 2D camera moves to a specific predefined area on the substrate disk, in which case the stationary camera takes a picture of the area of substrate disk and this is compared to the required image learned.

A halogen light source can be used as a light source here, with the light being reflected via beam splitters in the microscope optics. Alternatively light guides can be used to direct the light, guiding the light from the light source to the microscope. The advantage of this method lies in the fact that it can be used for structured substrate disks. Particular difficulties arise from the fact that the light has to be distributed homogeneously over the image surface. Using a 2D camera is also a disadvantage to the extent that the image size is dictated by the resolution of the 2D camera used.

### SUMMARY OF THE INVENTION

One possible object of the invention is to create an improved scanning device and an efficient, precise and reliable method for checking substrate disks during the fabrication process.

The inventors propose an optical scanning system for a substrate disk is provided, featuring an image recording device and an exposure device. The image recording device is used to scan an object line in a recording area on the substrate disk. The exposure device comprises a light source and an optical system, with the optical system being designed in such a way as to direct the light emitted by the light source as a linear exposure area onto the position of the object line and evenly distributed across the entire length of the object line to be scanned.

In accordance with a further aspect of the present invention, a method for optical scanning of a substrate disk is provided in which the object line is scanned in a recording area on the substrate disk. The object line is essentially evenly exposed in this case by a linear exposure area.

The optical scanning system is based on a combination of an image recording device which scans an object line in a recording area and an exposure device which directs light onto the object line in the recording area and distributes it evenly in an exposure area across the entire length of the object line to be recorded. The advantage is that the light which is essentially completely directed onto the object line, especially if a laser light source is used, has a high luminous intensity so that the exposure time of the recording device can be significantly reduced when recording an object line. The high luminous intensity also makes it possible to detect small process errors more easily. In addition it is technically more simple to implement even exposure of an object line rather than exposure of the entire recording area.

A further advantage is that, by contrast to known image recording devices, such as a CCD element for example, which can record full extent of a recording area, there is no need to restrict the size of the image area to be recorded because of the number of pixels of the CCD element used. In conjunction with a suitable image processing system recording areas of almost any size can be recorded by moving the object line in relation to the image recording device.

The optical scanning system also makes it possible to expose the area to be recorded on the substrate disk with a high-energy and homogeneous light source so that images can be recorded quickly by moving the recording area. This allows high scanning speeds to be reached with which the recording area can be scanned.

Preferably there is provision for the optical system to be designed in such a way as to allow the radiated light to spread out over the light of the object line to be recorded. This can be achieved for example with the aid of a cylinder optic system which produces a linear exposure area. The cylinder optics system is dimensioned so that the linear exposure area features roughly the length of the object line to be recorded. The use of an optical system which spreads the radiated light into a light strip is advantageous because light with a plurality of wavelengths or light of a wavelength range can be used. This has the advantage that the structures to be scanned can be recorded more accurately and in greater detail without interference disrupting the recorded image.

Provision can also preferably be made for the optical system to be designed in such a way that the radiated light of the light source is directed as an exposure area lying in one direction, preferably oscillating, essentially punctilinear area onto the object line. The position and the direction of movement of the exposure area corresponds to the position and orientation of the object line to be recorded. This has the advantage that the oscillating exposure area makes a significantly more even illumination of the object line possible than could be achieved by light breaking systems such as cylinder optics for example. The use of laser light is especially suitable for the oscillating exposure area. Laser light is especially suitable because the width of the exposure area can be defined to be very small and to a constant predefined width.

To have the exposure area oscillating in a defined way the optical system preferably features a moveable mirror which is connected to a position generator. The position generator can for example feature a piezo element or a motorized element. In particular the oscillating exposure area can be created by a suitable rotating mirror so that the exposure area oscillates in a transversal direction in a sine-wave-form to and fro movement. Since the image recording device normally scans the object line with one scanning frequency the oscillation of the exposure area should be synchronized to the scanning frequency of the recording device so that each of the pixels recorded at the time of recording is exposed evenly, i.e. with the same luminous intensity as the other pixels. This is preferably achieved by having the frequency of the oscillation of the exposure area greater than or equal to the scanning frequency of the image recording device, in which case it is especially preferred that the oscillation of the exposure area is an integer multiple of the scanning frequency. This is the way of achieving a system in which each pixel which is recorded by the image recording device is exposed by the light source at the point of recording.

To scan an extensive recording area provision can be made for the substrate disk to be scanned to be positioned on a substrate holder. The substrate holder can then move the substrate disk sideways to the alignment of the object line in order to scan consecutive image lines in the recording area. The substrate disk is preferably moved sideways by a predefined amount after each recording of an object line in order to record the next object line. The image recording device sends the recorded data for each object line to a processing unit or a memory for example with the recorded object lines being combined to form a complete image.

There is preferably provision for the light source to feature a laser light source. This has the advantage that the laser light source emits bundled light with higher luminous intensity through which the object line is exposed. This enables the speed of scanning of the scanning system to be improved because the exposure time of the image recording system can be reduced. In this way the resolution of the entire scanning system can be improved since a smaller width of the exposed area is selected than the resolution width of the image recording device. Thus the image recording device only perceives the exposed area when a recording the object line so that the width of the exposure area is decisive for the line resolution of the scanning system.

Provision can preferably be made for exposure to be undertaken with a plurality of light sources which are directed simultaneously or consecutively onto the object line. In this way it is possible to use of light with a plurality of wavelengths or light of a wavelength range to record the object line or so that better imaging is achieved. If for example a laser light source is used extinction phenomena are produced as a result of equal wavelength and coherence. Extinctions occur as a result of phase shifts caused by delay time differences, especially with unevenness in the recording area with a high rate of around a quarter (3/4;5/4 etc.) of the wavelength of the exposure radiation. Such extinction phenomena are avoided when exposure radiation with a plurality of wavelengths is used.

An ATDI (Time Delay Integration) line camera can thus also be used as a camera system in combination with the laser illumination or a discharge lamp or short-arc lamp. To extend the life or also to increase the light yield of the lamp, the lamp is operated in alternating mode, at 500 Hz for example. In alternating mode the ignition arcs are repeatedly regenerated. With normal cameras or line cameras this causes interruptions in the illumination and wide variations in brightness and stripes in the image recorded. The combination of the TDI camera and light sources with varying brightness mean that the stripes are smoothed or eliminated by the integration effect of the TDI camera.

The same applies when the TDI camera is used in combination with the laser light source. In this case the speckle patterns that would otherwise arise with normal camera systems are smoothed out or eliminated.

The TDI line camera possesses a light sensor line array of for example 96 lines, with each line possessing 2048 pixels. The lines are arranged above one another in a similar way to a 2D image sensor. In operation the image information for each line is integrated into the information of the following line. This requires a synchronization between object speed for line throughput speed with which the information of a line is integrated into the information of the following line. In this case of the direction of shift from line to following line corresponds to the direction of movement of the object. Through the use of the TDI camera the brightness is integrated so that the brightness sensitivity increases by a factor—number of lines multiplied by the efficiency.

### BRIEF DESCRIPTION OF THE DRAWINGS

These and other objects and advantages of the present invention will become more apparent and more readily appreciated from the following description of the preferred embodiments, taken in conjunction with the accompanying drawing of which:

The single FIGURE shows a scanning device in accordance with one possible embodiment of the present invention.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

The single drawing shows scanning system 1 in which a recording area 2 is scanned on a substrate disk (not shown) via an optical system 3 with a line camera 4.

The optical system 3 features a first lens 51 and a second lens 52 with which the object line 8 of the recording area 2 is exposed on an imaging plane in the line camera 4, so that a CCD element 6 arranged in the imaging plane can scan a line clearly and sharply.

The substrate disk is positioned on a substrate holder 13. The substrate holder 13 can shift the substrate disk in parallel (orientation P) to the recording area. When the recording area 2 is scanned, after each recording of an object line 8 by the scanning device 1, the substrate disk with the substrate holder 13 is moved by a specific amount and an object line 8 is recorded again, so that the scanning device 1 scans the recording area 2 in lines step-by-step. The substrate disk is preferably moved here essentially at right angles (orientation P) to the orientation of the object line 8. Directions of movement at an angle to the orientation of the object line 8 are also conceivable, in order to improve the positional accuracy of the substrate holder for example. The lateral offset essentially determines the line resolution of scanning system 1.

The CCD element 6 of the line camera 4 delivers image data for each object line which is forwarded to a processing unit 7. The processing unit 7 is connected to the line camera 4 and stores the received image data. The image data is combined here to form an image.

The image then corresponds to an image of the recorded area 2.

During the recording of the object line 8 in the recording area 2 the object line 8 is exposed by the optical system 3. So the exposure of the object line 8 is in the same optical axis where possible in which the object line 8 is scanned by the line camera, a beam splitter 9 is inserted into the optical system 3. The beam splitter 9 lets the beam reflected from the object line 8 to the line camera 4 through and is angled so that the exposure radiation of a laser light source 10 arranged to one side of the optical system 3 is reflected onto the object line 8. The beam splitter 9 is preferably designed as a semi-transparent mirror.

The laser light source 10 emits a laser beams. The laser beams L are deflected by a rotating angled mirror 12 so that they oscillate transversally in one direction. The transversely oscillating laser beams, shown by the dashed lines L1, L2, are directed via a further lens 11 onto the beam splitter 9 and reflected from there onto the object line 8 so that the transversely oscillating laser beams L1, L2 expose the object line 8. The object line 8 and the length of the area in which the laser beams L1, L2 oscillate transversally are essentially the same length. The area of oscillation of the laser beams L1, L2 can however also extend beyond the area of the object line 8 in order to use the almost linear part of the area of oscillation. The further lens 11 has the task of aligning the deflected laser beams L1, L2 in parallel. The parallelized laser beams L1, L2 are focused with the aid of the lens 52 onto the object line 8.

The fact that the oscillating mirror 12 rotates evenly means that the laser beams L are deflected in a specific area at different angles so that they execute a sine-wave-form transversal oscillation. This means that the laser beams L1, L2 are evenly distributed over the object line 8, i.e. the laser beams L1, L2 remain at the same point of the object line 8 for approximately the same period. Instead of a rotatable oscillating mirror 12 other devices can also be provided which cause a periodic transversal deflection or to-and-fro movement of the laser beams.

The resolution of the scanning system 1 is initially specified by the resolution of the line camera 4. The resolution of the line camera 4 comes into play when the exposure is made over the entire width of the object line 8 recorded by the line camera 4, i.e. when the width of the linear exposure area is equal to or greater than the resolution width of the line camera 4. The resolution of the scanning system 1 can however be increased further by using a narrower laser beam for which the width is less than at the resolution capability of line camera 4. The line camera 4, although it then still records the object line 8 over its entire resolution width, since however only a part of this is exposed, only the exposed part of the object line is visible to the line camera 4. The resolution can thus be increased by selecting the laser light source 10 so that the deflected laser beams L1, L2 feature a narrower width than the resolution width of the line camera 4 and by correspondingly reducing the lateral movement of the substrate disk for each new object line 8 to be recorded, so that the recorded object lines 8 essentially a adjoin one another.

The advantage of using the scanning system 1 as described above is that, because of the greater exposure energy which is obtained as a result of using a laser and bundling the light to a small area of an object line 8, use can be made of the fact that the CCD element 6 of the line camera 4 needs a shorter exposure time to scan the object line 8. In this way a higher speed of scanning of the recording area 2 of substrate disks can be achieved which increases the throughput on scanning for a wafer inspection.

Preferably, instead of one laser light source 10 a plurality of laser light sources or light with a broader spectrum can be used in order to obtain better imaging. If a laser 10 with only one wavelength is used interference can occur with structural unevenness which leads to the extinction or the weakening of the reflected beam. The interference can be avoided when light beams with a plurality of wavelengths or a wavelength range are used.

Normally line cameras 4 operate with scanning frequencies, i.e. the pixels of each line are scanned consecutively in accordance with a specific scanning frequency. Since the laser beams L are also moving to and fro as a result of the angled rotatable oscillating mirror 12, it is necessary to harmonize the scanning frequency and the frequency of the transversal to-and-fro movements of the laser beams. The movements must be harmonized in such a way that a point of the object line 8 to be recorded is passed over by the laser beams L1, L2 at the time of recording. This can be achieved for example by selecting the frequency of the laser beams L1, L2 oscillating to and fro to be equal to or an integer multiple of the scanning frequency of the line camera 4.

The image recorded in this way in the processing unit 7 is compared to a required image which produces deviations between the recording area just recorded and a required recording area. The deviations can be determined in accordance with a subtraction procedure. It is also possible to process the scanned image with the aid of a neural networks in order to detect process-related errors.

The invention has been described in detail with particular reference to preferred embodiments thereof and examples, but it will be understood that variations and modifications can be effected within the spirit and scope of the invention.

1-19. (cancelled)

20. An optical scanning system for a substrate disk, comprising:
an image recording device to scan and record an object line in a recording area on the substrate disk;
an exposure device to scan and illuminate the object line, comprising:
a light source to radiate light;
an optical system to direct light radiated from the light source onto an essentially punctilinear exposure area of the object line to evenly illuminate the object line across an entire length of the exposure area; and
a movable mirror positioned between the light source and the substrate disk to oscillate the punctilinear exposure area and thereby illuminate the object line.

21. The scanning system in accordance with claim 20, further comprising:
a movable substrate holder; and
a piezo element connected to the movable mirror and the movable substrate holder.

22. The scanning system in accordance with claim 21, wherein the movable substrate holder is motorized.

23. The scanning system in accordance with claim 20, wherein the movable mirror is a rotating mirror.

24. The scanning system in accordance with claim 21, wherein the optical system is designed in such a way as to cause a sine-wave-shaped transverse oscillation of the exposure area over the object line to be scanned.

25. The scanning system in accordance with claim 20, wherein
the image recording device scans the object line with a scanning frequency, and
the exposure device synchronizes illumination of the substrate with the scanning frequency.

26. The scanning system in accordance with claim 20, wherein
the image recording device scans the object line at a scanning frequency, and
the exposure frequency is greater than or equal to the scanning frequency.

27. The scanning system in accordance with claim 26, wherein the exposure frequency is an integer multiple of the scanning frequency.

28. The scanning system in accordance with claim 20, wherein
the substrate disk is mounted on a movable substrate holder, and
the substrate holder moves the substrate disk sideways relative to an orientation of the object line in order to scan the recording area.

29. The scanning system in accordance with claim 20, wherein the light source is a laser light source.

30. The scanning system in accordance with claim 20, wherein the light source is a plurality of light sources directed onto the object line.

31. The scanning system in accordance with claim 30, wherein the plurality of light sources radiate light at a plurality of respective different wavelengths.

32. The scanning system in accordance with claim 20, wherein the image recording device comprises a line camera.

33. The scanning system in accordance with claim 20, wherein the optical system has a selection unit to select a variable width of the linear exposure area.

34. The scanning system in accordance with claim 22, wherein the movable mirror is a rotating mirror.

35. The scanning system in accordance with claim 34, wherein the optical system is designed in such a way as to cause a sine-wave-shaped transverse oscillation of the exposure area over the object line to be scanned.

36. The scanning system in accordance with claim 35, wherein
the image recording device scans the object line with a scanning frequency, and
the exposure device synchronizes illumination of the substrate with the scanning frequency.

37. The scanning system in accordance with claim 36, wherein
the image recording device scans the object line at a scanning frequency, and
the exposure frequency is greater than or equal to the scanning frequency.

38. The scanning system in accordance with claim 37, wherein the exposure frequency is an integer multiple of the scanning frequency.

39. The scanning system in accordance with claim 38, wherein
the substrate disk is mounted on a movable substrate holder, and
the substrate holder moves the substrate disk sideways relative to an orientation of the object line in order to scan the recording area.

40. The scanning system in accordance with claim 39, wherein the light source is a laser light source.

41. The scanning system in accordance with claim 40, wherein the light source is a plurality of light sources directed onto the object line.

42. The scanning system in accordance with claim 41, wherein the plurality of light sources radiate light at a plurality of respective different wavelengths.

43. The scanning system in accordance with claim 42, wherein the image recording device comprises a line camera.

44. The scanning system in accordance with claim 43, wherein the optical system has a selection unit to select a variable width of the linear exposure area.

45. A method for optically scanning a substrate disk, comprising:
scanning and recording an object line in a recording area on the substrate disk;
radiating light from a light source;
directing light radiated from the light source onto an essentially punctlinear exposure area of the object line to thereby evenly eliminate the object line across an entire length of the exposure area;
moving a mirror positioned between the light source and the substrate disk to oscillate the punctlinear exposure area and thereby illuminate the object line; and
checking the quality of a surface layer of the substrate disk.

46. The method in accordance with claim 45, wherein
the object line is scanned and recorded at a scanning frequency, and
the light source is radiated toward the object line at a frequency synchronized with the scanning frequency.

47. The method in accordance with claim 46, wherein
the light source is radiated toward the object line at an exposure frequency of oscillation, and
the exposure frequency is greater than or equal to the scanning frequency.

48. The method in accordance with claim 47, wherein the exposure frequency is an integer multiple of the scanning frequency.
